(19) United States
(12) Patent Application Publication
(10) Pub. No.: US 2023/0405529 A1
(43) Pub. Date: Dec. 21, 2023

(54) ELEMENT FOR SEPARATING A LIQUID MEDIUM WITH HIGH PARIETAL SHEAR STRESS

(71) Applicant: TECHNOLOGIES AVANCEES ET MEMBRANES INDUSTRIELLES, Nyons (FR)

(72) Inventors: Philippe LESCOCHE, Nyons (FR); Jérôme ANQUETIL, Nyons (FR)

(73) Assignee: TECHNOLOGIES AVANCEES ET MEMBRANES INDUSTRIELLES, Nyons (FR)

(21) Appl. No.: 18/250,819

(22) PCT Filed: Nov. 19, 2021
(86) PCT No.: PCT/FR2021/052038

§ 371 Date: Apr. 27, 2023

(30) Foreign Application Priority Data
Nov. 23, 2020 (FR) FR2012009

(51) Int. Cl. B01D 63/06; B01D 67/00

(52) U.S. Cl. CPC B01D 63/066; B01D 67/0041; B33Y 80/00

(57) ABSTRACT

The subject of the invention relates to a separating element comprising:
an inorganic one-piece rigid porous support (2) having, on one side, a first outer planar surface (3) and, on an opposite side, a second outer planar surface (4);
at least two circulation ducts (6) for the liquid medium that are formed in the porous support so as to each have a rectangular cross section;
at least one internal connection system for the distribution (10) of the liquid medium in a series of circulation ducts, and at least one internal connection system for the collection (12) of the retentate coming from the series of circulation ducts, the internal connection system for the distribution (10), the circulation ducts (6) and the internal connection system for the collection (12) being provided with at least one separating layer continuously deposited between the inlet (11) and the outlet (13) of the porous support;
and a collection system (7) for the permeate that has passed through the separating layer or layers.

### TECHNICAL FIELD

The present invention relates to the technical field of elements for separating, by tangential flow, a liquid medium to be treated into a filtrate or permeate and a retentate, commonly called filtration membranes.

More specifically, the invention relates to new geometries of these separating elements allowing to increase the flow of the filtrate and/or to reduce the energy consumption of the installations implementing these separating elements.

### PRIOR ART

Separation methods using membranes are used in many sectors, in particular in the environment for the production of drinking water and the treatment of industrial effluents, in the chemical, petrochemical, pharmaceutical, food industry and in the field of biotechnology.

A membrane constitutes a selective barrier which allows, under the action of a transfer force, the passage or the stopping of certain components of the fluid medium to be treated. The passage or the stopping of the components results from their size compared to the size of the pores of the membrane which then behaves like a filter. Depending on the pore size, these techniques are called microfiltration, ultrafiltration or nanofiltration.

There are membranes of different structures and textures. The membranes are generally made up of a porous support which provides the mechanical strength of the membrane and which, defining the number and morphology of the circulation ducts for the liquid medium to be treated, determines the total filtering surface of the membrane. It is in fact on the inner walls of these circulation ducts that a layer called a separating layer, filtration layer, separation layer, active layer or skin ensures the separation. During the separation, the transfer of the filtered liquid medium takes place through the separating layer, then this liquid spreads in the porous texture of the support to move towards the outer perimeter surface of the porous support. This part of the liquid to be treated that has passed through the separation layer and the porous support is called permeate or filtrate and is recovered by a collection system. The other part is called retentate and is most often reinjected into the liquid to be treated upstream of the membrane, thanks to a circulation loop.

The main phenomenon antagonistic to the transfer of the filtrate through the separation layer is the appearance of clogging resulting from a concentration polarization, a deposition or a blockage of the pores. Regardless of the nature of the filtering layer used to carry out a filtration operation and regardless of the nature of the liquid medium to be treated, there always appears from the start of the filtration operation, a drop in the permeation flow which is the consequence of said clogging of the separation layer and which can sometimes be extremely strong and rapid.

The phenomenon of concentration polarization operates during a filtration operation when the macromolecules present in the liquid medium to be treated concentrate at the membrane/solution interface where they exert an osmotic counter-pressure opposite to the separation force or backdiffuse into the center of the liquid medium to be treated according to Fick's law. The phenomenon of concentration polarization results from the accumulation of the compounds retained in the vicinity of the membrane due to the permeation of the solvent.

It is when the concentration of particles at the surface of the membrane increases until it causes the appearance of a condensed phase in the form of a gel or a cohesive deposition that a hydraulic resistance additional to that of the diaphragm appears. Pore blocking occurs when there is intrusion of particles of size less than or equal to those of the pores, which leads to a reduction in the filtering surface.

Clogging, its reversibility or its irreversibility, are complex phenomena which depend on the filtration element and in particular on the separating layers, on the liquid to be treated and on the operating parameters.

Clogging is a major obstacle to the economic attractiveness of filtration because it leads, when sizing filtration installations, to increasing the installed surfaces in order to meet the volume requirements to be treated on the one hand and it necessitates the implementation of specific technical means to overcome this a posteriori, such as cleaning cycles using detergents or periodic retro-filtrations on the other hand.

To eliminate, limit or delay said accumulation of material, the positive effect of the continuous flow speed of a fluid to be treated tangentially to the surface of a filtering layer has been widely studied and described in the prior art.

It is thus in fact that the current interest of tangential filtration of liquids lies in a continuous and controlled circulation of the liquid medium to be treated (the retentate) inside circulation ducts under conditions of speed and pressure which act on the amplitude and the kinetics of the clogging of the filtering layer, the speed of movement of the retentate generating a parietal shear stress τₚ which slows down the clogging, hence an increase in the flow rate of the filtrate (of the permeate) in the porosities of the filtering layer and its support.

The higher the speed, the higher the value of the parietal stress τₚ and the more the clogging is reduced or delayed. But the disadvantage is that this “speed effect” on the one hand requires an increase in power which generally works against it and on the other hand does not allow to compare circulation ducts of different cross sections.

It is the access to the value of the parietal shear stress τₚ (wall shear stress) itself which allows to compare circulation ducts of different cross sections. First H. Barnier “Colmatage de membranes minérales d'ultrafiltration ou de microfiltration dans les bio-industries”, Membranes and Bio-industries Study Days, Paris (France), (1993) then G. Gésan-Guiziou, G. Daufin, E. Boyaval, O. Le Berre, “Wall shear stress: effective parameter for the characterisation of the cross-flow transport in turbulent regime during skimmed milk microfiltration”, Milk, 79, 347-354, (1999) consider that the parietal stress is the only parameter which allows, for the same fluid to be treated, to compare their performances.

The parietal shear stress represents the forces applied by the fluid flowing tangentially to the surface of the membrane on a membrane surface element.

It is a homogeneous quantity at a pressure and its unit is the pascal (Pa) or N·m⁻². It can be experimentally determined with the following relationship:

$${τ}_{p} = \frac{d \cdot Δ p}{4 \cdot L}$$

where d is the hydraulic diameter and L the length of the circulation duct.

It is dependent on the nature of the liquid medium (its viscosity) via the pressure drop Δp, the Darcy friction factor f_{D} (dimensionless number) and the Reynolds number Re in accordance with the following relationships:

$$Δ p = {f}_{D} \cdot \frac{L}{d} \cdot \frac{1}{2} \cdot ρ \cdot {V}^{2}$$

Let:

$${τ}_{p} = \frac{{f}_{D}}{8} \cdot ρ \cdot {V}^{2}$$

where f_{D}, in the case of a circulation duct with circular cross section and in laminar flow regime, is equal to: f_{D}=64/Re, the coefficient 64 being characteristic of a circulation duct with a circular cross section.

The authors Yunus A. Cengel and John M. Cimbala, in their book “Mécanique des Fluides, Fondements et Applications” Copyright 2017 by De Boeck Superieur (Translation by A. Chagnes, S. Griveau, V. Lair and A. Ringuedé), specify that this coefficient varies according to the geometry of the cross section of the circulation duct of the fluid to be treated. It emerges from this work that at identical Reynolds, the friction factor becomes higher than that of a circulation duct with a circular cross section, for a circulation duct with a strongly flattened rectangular cross section.

Under these conditions, and all other things being equal, the parietal shear stress τₚ in such a circulation duct is greater than that in a circulation duct with a circular or square cross section, thus allowing more effective unclogging and a gain on the permeation flux.

The prior art has proposed various embodiments of filtration membranes with circulation ducts of rectangular section. For example, patent FR 2 696 653 describes a filtration unit including a rigid porous structure interposed between a thrust plate and a counter-thrust plate. The rigid porous structure has main planar faces covered by a separating layer in contact with the liquid medium to be treated flowing between these main faces and the thrust and counter-thrust plates. This solution requires the implementation of thrust and counter-thrust plates.

The subject of the invention proposes to provide new rigid filtration elements with a geometry adapted to ensure effective unclogging with a view to increasing the flow of the filtrate while being easy to manufacture.

### DISCLOSURE OF THE INVENTION

To achieve such a purpose, the subject of the invention relates to an element for separating a liquid medium to be separated into a permeate and a retentate including:
an inorganic one-piece rigid porous support having, on one side, a first outer planar surface and, on an opposite side, a second outer planar surface connected to the first outer planar surface by at least one outer connecting surface;
at least two circulation ducts for the liquid medium that are formed in the porous support so as to each have a rectangular cross section;
at least one internal connection system for the distribution of the liquid medium, arranged in the porous support to distribute from an inlet formed in the porous support, the liquid medium, in a series of circulation ducts, and at least one internal connection system for the collection of the retentate, arranged in the porous support to collect up to an outlet formed in the porous support, the retentate coming from the series of circulation ducts, the internal connection system for the distribution, the circulation ducts and the internal connection system for the collection being provided with at least one separating layer continuously deposited between the inlet and the outlet of the porous support so that the liquid medium circulating in the porous support between the inlet and the outlet is only in contact with said separating layer, the porous support having a continuity of material and of porous texture and a mechanical strength allowing to prevent the breaking of the porous support for a pressure difference of the liquid medium of at least one bar between the separating layer and the outlet surface of the permeate;
and a collection system for the permeate that has passed through the separating layer or layers.

Advantageously, the porous support is obtained by the implementation of an additive method adapted so that the porosity of the porous material ensures the routing of the permeate that has passed through the separating layer or layers.

Typically, the constituent material of the porous support has a maximum allowable bending stress of at least 10 MPa.

According to an advantageous embodiment characteristic, the rectangular cross section of the circulation ducts has two dimensions, one of the dimensions of which is at least four times smaller than the other dimension.

For example, several circulation ducts are formed in the porous support parallel to each other.

According to another example, at least one circulation duct has a flexible shape while following the main direction of circulation of the fluid to be treated.

For example, at least one circulation duct has a periodic flexible shape.

According to one embodiment, each circulation duct has a constant cross section over its entire extent between the internal connection system for the distribution and the internal connection system for the collection.

According to an exemplary embodiment, the circulation ducts are delimited by two parallel faces which are perpendicular or parallel to at least two outer planar surfaces of the porous support.

According to a variant embodiment, the internal connection system for the distribution and the internal connection system for the collection open onto the outside of the porous support via one or more orifices or nozzles arranged at an outer planar surface or at an outer connecting surface.

For example, the internal connection system for the distribution and the internal connection system for the collection are arranged asymmetrically on either side of the circulation ducts.

According to another example, the internal connection system for the distribution and the internal connection system for the collection are arranged symmetrically on either side of the circulation ducts.

According to one embodiment characteristic, the collection system for the permeate includes spaces arranged inside the porous support to collect the permeate that has passed through the separating layer or layers.

Typically, the collection system for the permeate opens onto the outside of the porous support via one or more orifices or nozzles for collecting said permeate.

The first outer planar surface, the second outer planar surface and the outer connecting surface are sealed.

According to one embodiment characteristic, the collection system for the permeate is recessed in at least one outer planar surface of the porous support to collect the permeate that has passed through the separating layer or layers, the rest of the outer planar surface not recessed being sealed.

For example, the porous support includes nozzles sealed on the outside, delimiting the inlet of the internal connection system for the distribution and the outlet of the internal connection system for the collection.

The nozzles extend along directions whose angles relative to the main direction of circulation of the liquid medium are comprised between 0° and 90°.

Another subject of the invention is to provide a separation unit including at least one separating element mounted in an apparatus provided with connections to ensure on the one hand the entry of the liquid medium to be treated and the exit of the retentate as well as on the other hand the collection of the permeate the nozzles of which delimit the inlet of the internal connection system for the distribution of the liquid medium to be treated and the outlet of the internal connection system for the collection of the retentate, the permeate collection nozzles being equipped with connections fixed in a sealed manner to said nozzles.

### BRIEF DESCRIPTION OF THE DRAWINGS

FIG. 1 is a schematic representation in longitudinal section taken substantially along section lines B-B of FIG. 2, of a separating element illustrating the general principle of the subject of the invention.

FIG. 2 is a cross sectional view of the separating element, taken substantially along section lines A-A of FIG. 1.

FIG. 3 is a perspective view illustrating a first exemplary embodiment of a separating element in accordance with the invention relating to the mode with connecting nozzles.

FIG. 4 is a cross sectional view taken along lines IV-IV of FIG. 3.

FIG. 5 is a longitudinal sectional view taken along lines V-V of FIG. 4.

FIG. 6 is a perspective view illustrating another exemplary embodiment of a separating element in accordance with the invention relating to the mode with connecting nozzles.

FIG. 7 is a sectional plan view taken along lines VII-VII of FIG. 6.

FIG. 8 is a sectional plan view taken along lines VIII-VIII of FIG. 7.

FIG. 9 is a cross sectional view taken along lines IX-IX of FIG. 8.

FIG. 10 is a longitudinal sectional view taken along lines X-X of FIG. 6.

FIG. 11 is a perspective view similar to FIG. 6 illustrating another exemplary embodiment for the connecting nozzles of the separating element in accordance with the invention.

FIG. 12 is a perspective view illustrating another exemplary embodiment of a separating element in accordance with the invention having a design identical to the exemplary embodiment illustrated in FIG. 6 but with an inlet and an outlet for the liquid medium, made asymmetrically.

FIG. 13 is a perspective view similar to FIG. 12, illustrating another exemplary embodiment with threaded connection ends.

FIG. 13A is a perspective view with a longitudinal section taken substantially along lines A-A of FIG. 13.

FIG. 13B is a longitudinal sectional view taken substantially along lines B-B of FIG. 13.

FIG. 13C is a cross sectional view taken substantially along lines C-C of FIG. 13.

FIG. 13D is a plan sectional view taken substantially along lines D-D of FIG. 13.

FIG. 14 is a perspective view illustrating another exemplary embodiment of a separating element according to the invention relating to the mode with connection orifices, produced in the form of a rectangular parallelepiped with the circulation ducts for the liquid medium arranged perpendicular to the outer planar surfaces.

FIG. 15 is a plan sectional view taken along lines XV-XV of FIG. 14.

FIG. 16 is a cross sectional view taken along lines XVI-XVI of FIG. 14.

FIG. 17 is a cross sectional view taken along lines XVII-XVII of FIG. 16.

FIG. 18 is a longitudinal sectional view taken along lines XVIII-XVIII of FIG. 14.

FIG. 19 is a perspective view illustrating another exemplary embodiment of a separating element according to the invention relating to the mode with connection orifices, produced in the form of a rectangular parallelepiped and including a system for recovering the permeate only on the surface of the porous support.

FIG. 20 is a plan sectional view taken along lines XX-XX of FIG. 19.

FIG. 21 is a cross sectional view taken along lines XXI-XXI of FIG. 19.

FIG. 22 is a longitudinal sectional view taken along lines XXII-XXII of FIG. 19.

FIG. 23 is a longitudinal sectional view of a variant embodiment similar to FIG. 22 and in which the circulation ducts for the liquid medium are arranged in two superimposed rows.

FIG. 24 is a view illustrating in negative the circulation ducts and the permeate recovery system of the variant embodiment illustrated in FIG. 23.

FIG. 25 is a perspective view illustrating another exemplary embodiment of a separating element in accordance with the invention, relating to the mode with connection orifices produced in the form of a rectangular parallelepiped with the circulation ducts for the liquid medium arranged parallel to the outer planar surfaces.

FIG. 26 is a cross sectional view taken along lines XXVI-XXVI of FIG. 25.

FIG. 27 is a longitudinal sectional view taken along lines XXVII-XXVII of FIG. 25.

FIG. 28 is a cross sectional view taken along lines XXVIII-XXVIII of FIG. 25.

FIG. 29 is a plan sectional view taken along lines XXIX-XXIX of FIG. 25.

FIG. 30 is a perspective view of an exemplary embodiment of a commercial apparatus provided with connections for the connection of a separating element relating to the mode with connection orifices and in accordance with one of the variants illustrated in FIGS. 14 to 29.

FIG. 31 is an exploded view of the exemplary embodiment of the apparatus illustrated in FIG. 30.

### DESCRIPTION OF EMBODIMENTS

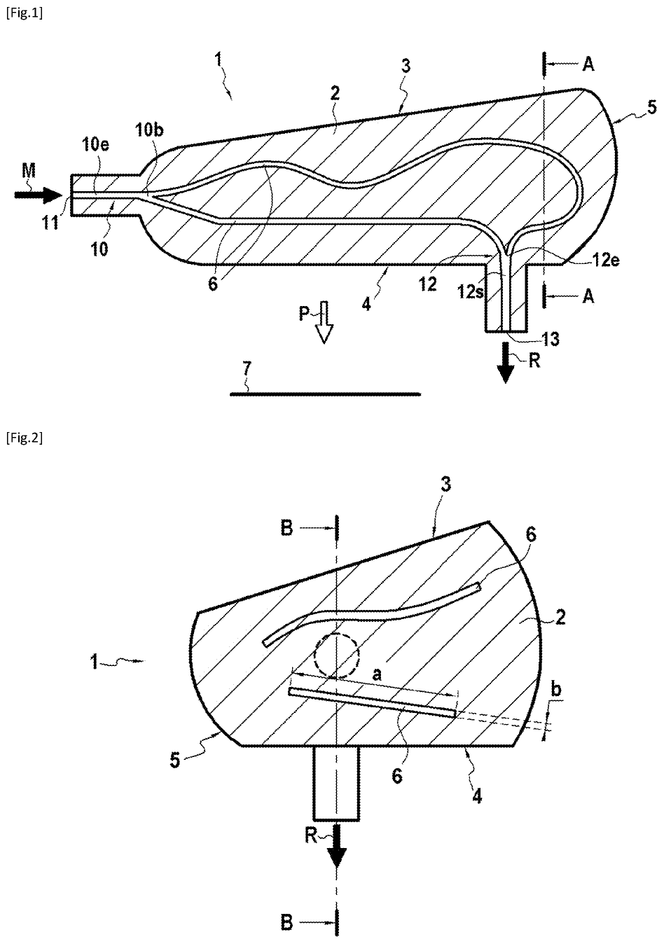

The subject of the invention relates to a separating element 1, by tangential flow of a liquid medium M to be separated into a permeate or filtrate P and a retentate R. This liquid medium to be treated can be of any nature. In accordance with FIGS. 1 and 2 which generally illustrate the characteristics of the invention without representing all the details for reasons of clarity, the separating element 1 includes an inorganic one-piece rigid porous support 2 having, on one side, a first outer planar surface 3 and, on an opposite side, a second outer planar surface 4 connected to the first outer planar surface by at least one connecting surface 5. At least two circulation ducts 6 for the liquid medium to be treated are formed in the porous support 2 being provided on their inner faces with at least one separating layer.

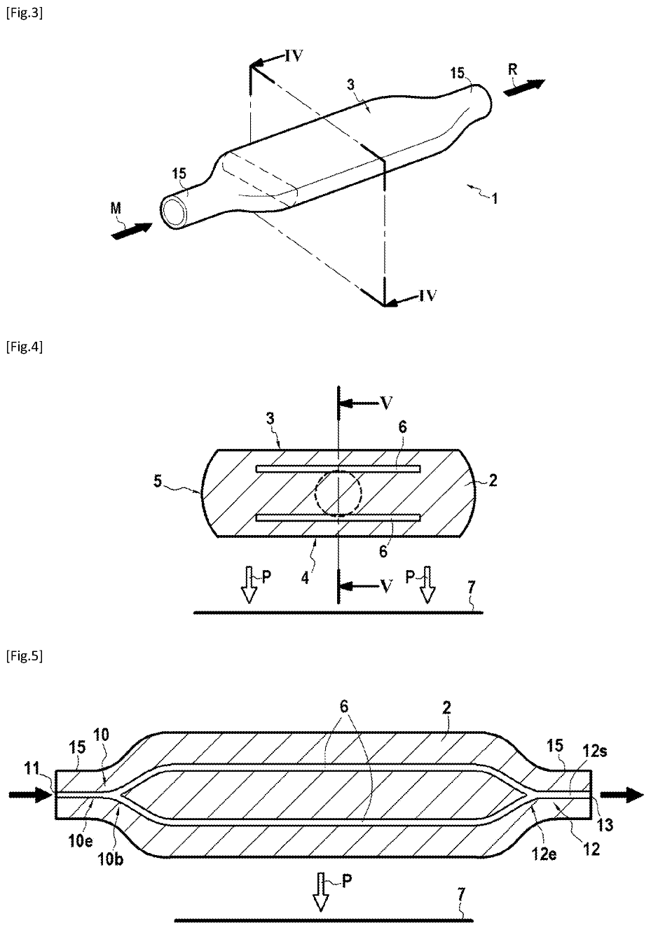

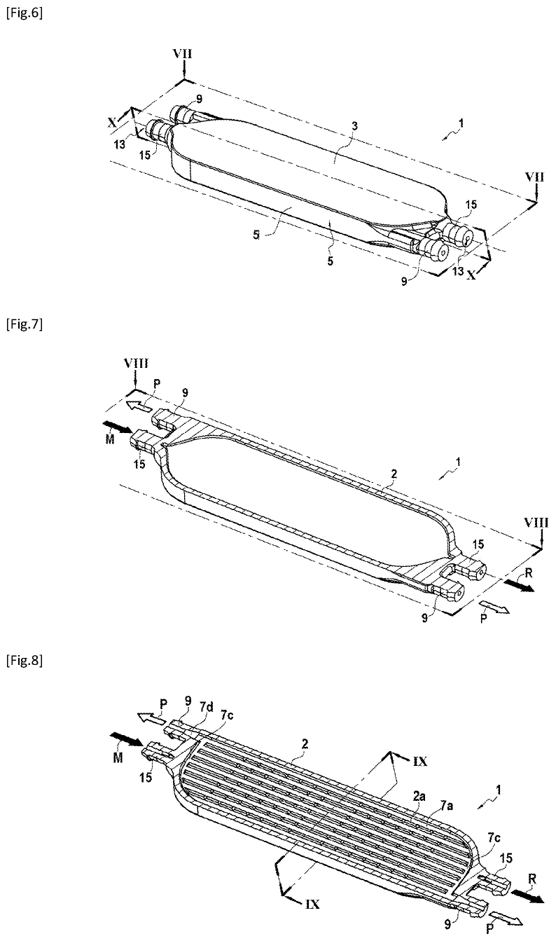

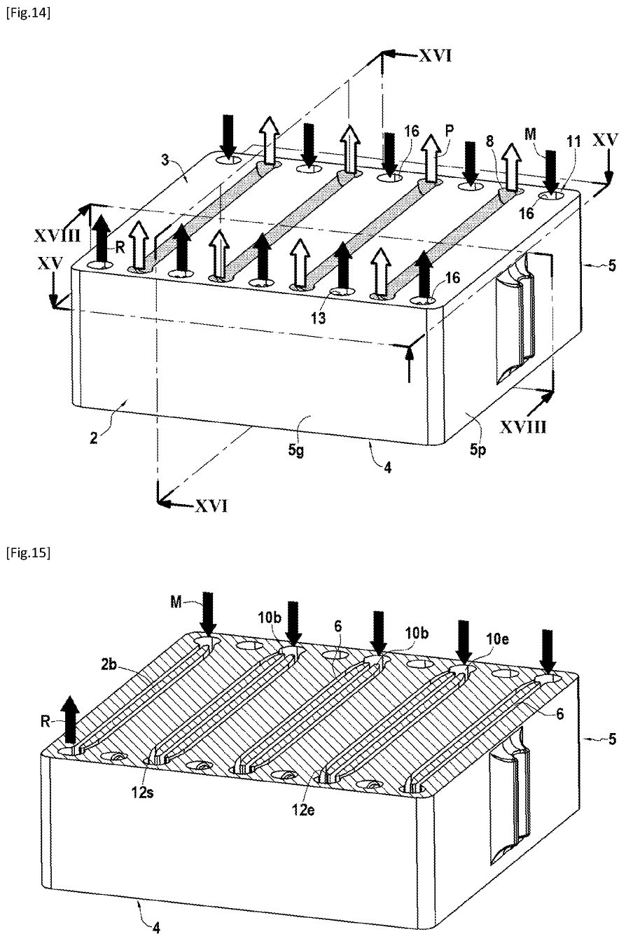

Given that the rigid porous support 2 has a first outer planar surface 3 and a second outer planar surface 4 located opposite or facing each other, the separating element 1 has an optimized geometry. It should be noted that in the example illustrated in FIGS. 1 and 2, the first outer planar surface 3 and the second outer planar surface 4 are not parallel to each other. According to a preferred variant embodiment illustrated in FIG. 3 and subsequent figures, the first outer planar surface 3 and the second outer planar surface 4 are parallel to each other, offering the possibility of stacking the separating elements 1 on top of each other. The connecting surface 5 between these two outer planar surfaces 3, 4 can be produced in any appropriate way, for example by a curved surface or a planar surface perpendicular to the outer planar surfaces 3, 4 by defining one or more connecting faces. This connecting surface 5 can define, for example, two parallel to each other connecting faces as illustrated in FIGS. 3 to 11 or four connecting faces parallel to each other two by two as illustrated in FIG. 14 and subsequent figures so that the porous support 2 has the shape of a rectangular parallelepiped.

In such separating elements 1, the body constituting the porous support 2 has a porous texture. This porous texture is characterized by the average pore diameter. It is recalled that the average pore diameter means the value d50 of a volume distribution for which 50% of the total pore volume corresponds to the volume of pores with a diameter less than this d50. The volume distribution is the curve (analytical function) representing the frequencies of the pore volumes as a function of their diameter. The d50 corresponds to the median dividing into two equal parts the area located under the frequency curve obtained by mercury penetration. In particular, the technique described in standard ISO 15901-1:2005 can be used as regards the measurement technique by penetration of mercury.

The porosity of the porous support, which corresponds to the total volume of the interconnected voids (pores) present in the material considered, is a physical quantity which conditions the flow and retention capacities of said porous body. In order for the material to be used in filtration, the total interconnected open porosity must be at least 10% for a satisfactory flow of filtrate through the support, and at most 60% in order to guarantee an appropriate mechanical strength of the porous support.

The porosity of a porous support can be measured by determining the volume of a liquid contained in said porous body by weighing said material before and after a prolonged stay in said liquid (water or other solvent). Knowing the respective densities of the material considered and of the liquid used, the mass difference, converted into volume, is directly representative of the volume of the pores and therefore of the total open porosity of the porous support.

Other techniques allow to precisely measure the total open porosity of a porous support, including:
mercury intrusion porosimetry (ISO 15901-1 standard mentioned above): injected under pressure, the mercury fills the pores accessible to the pressures applied, and the volume of mercury injected then corresponds to the volume of the pores;
small-angle scattering: this technique, which uses either neutron radiation or X-rays, gives access to physical quantities averaged over the entire sample. The measurement consists of analyzing the angular distribution of the intensity scattered by the sample;
the analysis of 2D images obtained by microscopy;
the analysis of 3D images obtained by X-ray tomography.

The porous support 2 has an average pore diameter in the range from 0.5 μm to 50 μm. The porosity of the porous support 2 is comprised between 10 and 60%, preferably between 20 and 50%.

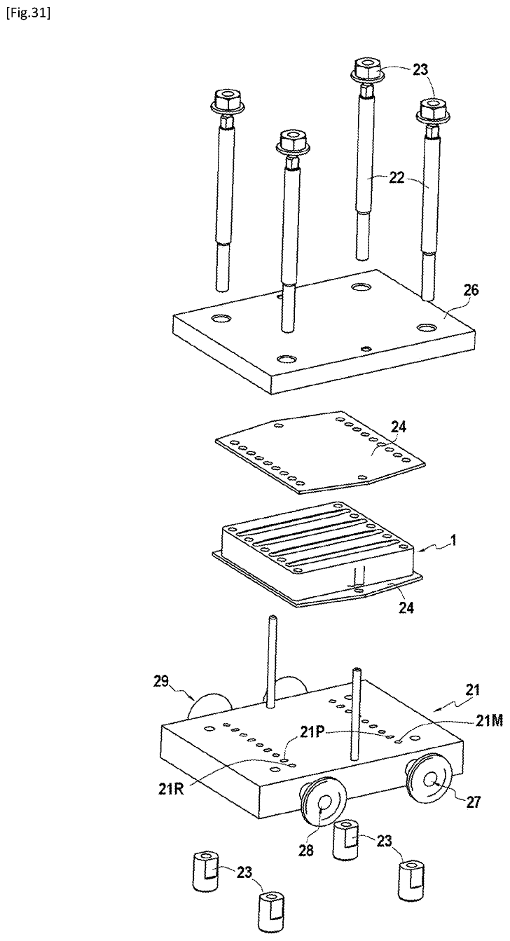

The porosity of the porous support 2 is open, that is to say it forms an array of interconnected pores in three dimensions, which allows the fluid filtered by the separating layer or layers to pass through all or part of the porous support 2 to a collection system 7 for the permeate P that has passed through the separating layer or layers. As described in detail in the remainder of the description, the collection system 7 for the permeate P is arranged in the porous support 2 or as illustrated in FIGS. 1 to 5, outside the porous support 2. In the case where the collection system 7 for the permeate P is arranged in the porous support 2, the collection system 7 opens onto the outside of the porous support 2 through one or more orifices 8 or nozzles 9 for collecting the permeate communicating with an external permeate recovery circuit. Such an external permeate recovery circuit can be made in any appropriate way and includes in particular, for example, either an apparatus provided with connections as described in FIGS. 30 and 31 when the collection system 7 opens onto the outside of the porous support 2 through orifices 8 or pipes provided with connections intended to be fixed in a sealed manner on the nozzles 9 when the collection system 7 opens onto the outside of the porous support 2 through such nozzles.

It is customary to measure the water permeability of the porous support 2 to qualify the hydraulic resistance of the porous support. Indeed, in a porous medium, the stationary flow of an incompressible viscous fluid is governed by Darcy's law. The speed of the fluid in the porosity (the permeate) is proportional to the pressure gradient and inversely proportional to the dynamic viscosity of the fluid, via a characteristic parameter called permeability which can be measured, for example, according to the French standard NF X 45-101 in December 1996.

Conventionally, the separating layer or layers used in the context of the invention ensure the filtration of the liquid medium to be treated. The filtration separating layers, by definition, must have an average pore diameter smaller than that of the porous support. The separating layers delimit the surface of the tangential flow separating element intended to be in contact with the liquid medium to be treated and along which the liquid medium to be treated will circulate.

The thicknesses of the filtration separating layers typically vary between 1 μm and 100 μm in thickness. Of course, to ensure its separation function and serve as an active layer, the separating layers have an average pore diameter less than the average pore diameter of the porous support. Most often, the average pore diameter of the filtration separating layers is at least less by a factor of 3, and preferably, by at least a factor of 5 relative to that of the porous support.

The notions of microfiltration, ultrafiltration and nanofiltration separating layer are well known to the person skilled in the art. It is generally accepted that:
microfiltration separating layers have an average pore diameter comprised between 0.1 μm and 10 μm;
the ultrafiltration separating layers have an average pore diameter comprised between 10 nm and 0.1 μm;
the nanofiltration separating layers have an average pore diameter comprised between 0.5 nm and 10 nm.

It is possible for this micro or ultrafiltration layer, called active layer, to be deposited directly on the porous support, or else on an intermediate layer of smaller average pore diameter, itself deposited directly on the porous support.

The separation layer may, for example, consist of a ceramic, selected from oxides, nitrides, carbides or other ceramic materials and mixtures thereof, and, in particular, titanium oxide, alumina, zirconia or a mixture thereof, titanium nitride, aluminum nitride, boron nitride, silicon carbide optionally mixed with another ceramic material.

The separation layer can also, for example, consist of one or more polymers such as PAN, PS, PSS, PES, PVDF, cellulose acetate or other polymers.

According to one characteristic of the invention, the separating element 1 includes at least one internal connection system for the distribution 10 of the liquid medium to be treated, arranged in the porous support 2 to distribute from at least one inlet 11 formed in the porous support 2, the liquid medium to be treated, in a series of circulation ducts 6. The separating element 1 also includes at least one internal connection system for the collection 12 of the treated liquid medium, arranged in the porous support 2 to collect up to at least one outlet 13 formed in the porous support 2, the treated liquid medium coming from the series of circulation ducts 2. It should be understood that the internal connection system for the distribution 10, the series of circulation ducts 6 and the internal connection system for the collection 12 are formed by empty spaces for the circulation of the liquid medium, that is to say by areas of the porous support 2 not including any porous material.

The internal connection system for the distribution 10 is arranged so as to distribute the liquid medium in a series of circulation ducts 6 from an inlet 11 for the liquid medium M formed in the porous support 2. Typically, this internal connection system for the distribution 10 includes from an inlet 11, a common inlet segment 10e opening into a bifurcation or crossing 10b made by the porous support to include as many distribution channels as circulation ducts 6. As will be explained in detail in the following description, the internal connection system for the distribution 10 opens via its inlet 11, onto the outside of the porous support 10 via one or more nozzles 15 or orifices 16 formed at an outer planar surface 3, 4 or at an outer connecting surface 5. The inlet 11 for the liquid medium to be treated communicates with an external circulation circuit that can be produced in any appropriate manner. This external circulation circuit includes in particular, for example, either an apparatus provided with connections as described for example in FIGS. 30 and 31 when the internal connection system for the distribution 10 opens onto the outside of the porous support 2 through orifices 16 or pipes provided with connections intended to be fixed in a sealed manner on the nozzles 15 when the internal connection system for the distribution 10 leads to the outside of the porous support 2 through such nozzles 15.

Similarly, the internal connection system for the collection 12 is arranged in the porous support 2 to recover the liquid medium from the liquid ducts and convey it to the outlet 13 arranged in the porous support 2 and ensuring the evacuation of the retentate R. Typically, the internal connection system for the collection 12 includes, from an outlet 13, a common outlet segment 12s opening into a branch or crossing 12e made by the porous support to include as many collection paths as circulation ducts 6. As will be explained in detail in the following description, the internal connection system for the collection 12 opens via the outlet 13, onto the outside of the porous support 2 by one or more nozzles 15 or orifices 16 arranged at an outer planar surface 3, 4 or at an outer connecting surface 5. The outlet 13 for the retentate communicates with an external circulation circuit that can be produced in any appropriate manner. This external circulation circuit includes in particular, for example, either an apparatus provided with connections as described for example in FIGS. 30 and 31 when the internal connection system for the collection 12 opens onto the outside of the porous support 2 through orifices 16 or pipes provided with connections intended to be fixed in a sealed manner on the nozzles 15 when the internal connection system for the collection 12 opens onto the outside of the porous support 2 via such nozzles 15.

In the example illustrated in FIGS. 1 and 2, the internal connection system for the distribution 10 and the internal connection system for the collection 12 are arranged asymmetrically on either side of the circulation ducts 6. It should be noted that the internal connection system for the distribution 10 and the internal connection system for the collection 12 can be arranged symmetrically on either side of the circulation ducts 6, as in the examples illustrated in FIG. 3 and subsequent figures.

In the example illustrated in FIGS. 1 and 2, the separating element 1 includes two circulation ducts 6 communicating on one side with an inlet 11, via the internal connection system for the distribution 10 and on the opposite side with an outlet 13 via the internal connection system for the collection 12. Of course, as will be described in detail in the various variant embodiments, the separating element 1 may include between an inlet 11 and an outlet 13, a series of circulation ducts 6 greater than two. Similarly, the separating element 1 can include several inlets 11 and several outlets 13, as well as several series of circulation ducts 6, each of which communicates with an inlet 11 and an outlet 13.

According to an advantageous characteristic of the invention, the internal connection system 10 for the distribution of the liquid medium to be treated, the circulation ducts 6 and the internal connection system for the collection 12 of the treated liquid medium are provided with at least one separating layer continuously deposited between the inlet 11 and the outlet 13 of the porous support 2 so that the liquid medium circulating in the porous support 2 between the inlet 11 and the outlet 13 is only in contact with said separating layer. In other words, the internal faces of the internal connection system for the distribution 10, of the circulation ducts 6 and of the internal connection system for the collection 12 are provided with at least one separating layer. It follows that the liquid medium circulates in the porous support 2 while only being in contact with a separating layer.

According to a characteristic of the subject of the invention, the circulation ducts 6 for the liquid medium to be treated are formed in the porous support 2 so as to each have a rectangular cross section defined by two long sides parallel to each other of length a and two short sides parallel to each other of width b. The rectangular cross section of the circulation ducts 6 is taken perpendicular to the flow lines of the liquid to be treated. As it appears from FIG. 1, it should be noted that the sides of the rectangular cross section of the circulation ducts 6 are not necessarily rectilinear. However, according to a preferred variant embodiment, all the sides of the rectangular cross section of the circulation ducts 6 are rectilinear. Advantageously, the rectangular cross section of the circulation ducts 6 is constant along their entire length or extended, namely over the distance taken between the internal connection system for the distribution 10 and the internal connection system for the collection 12.

According to an advantageous embodiment characteristic, one of the dimensions, namely the width b of the short sides of the rectangular cross section, is at least four times less than the other dimension, namely the length a of the long sides of the rectangular cross section of the circulation ducts 6. For example, the width b of the short sides of the rectangular cross section is between 4 and 80 times less than the length a of the long sides of the rectangular cross section of the circulation ducts 6.

The description which follows gives, by way of non-limiting illustration, various variant embodiments of the separating element 1 in accordance with the invention, the general principle of which is described in relation to FIGS. 1 and 2. All the characteristics of the invention described in relation to FIGS. 1 and 2 are implemented by these different embodiments even if these characteristics are not described in detail for each of them.

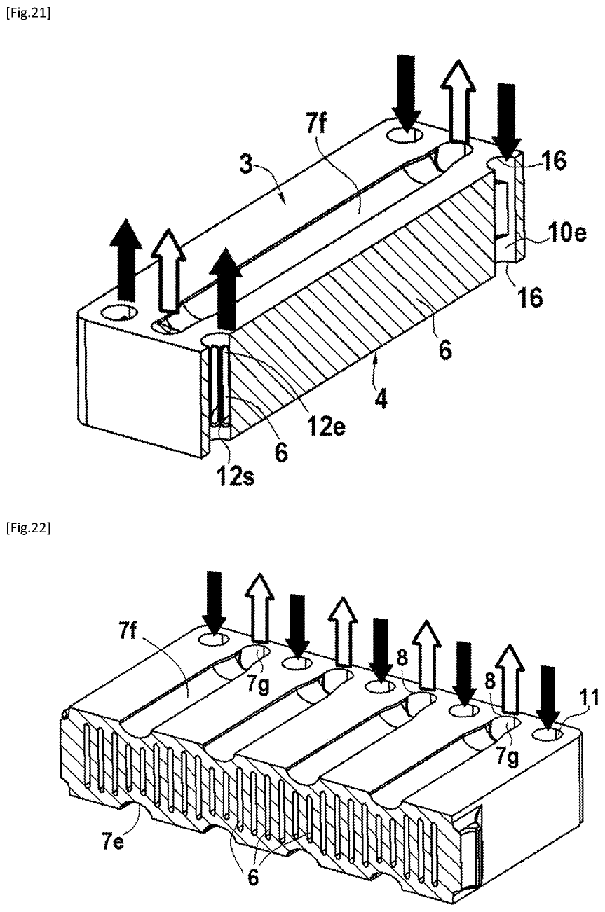

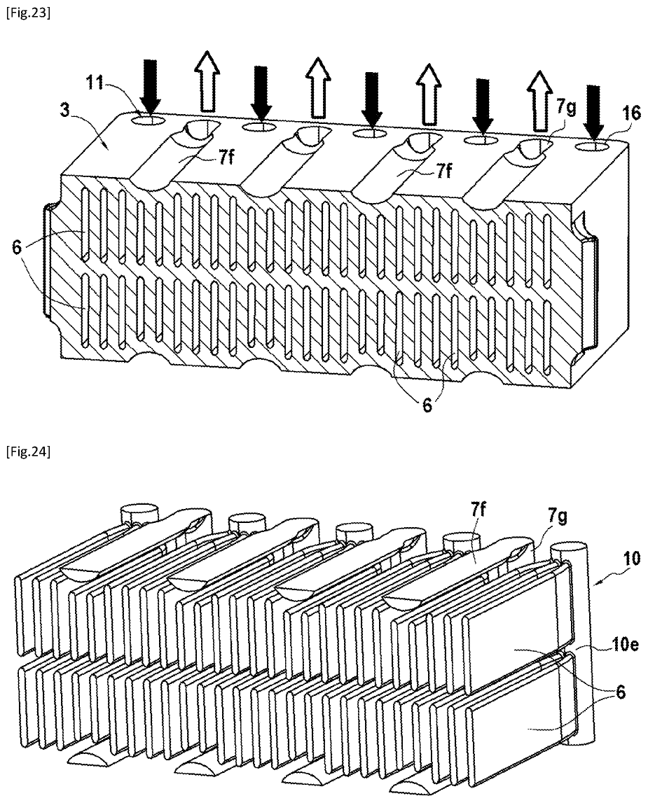

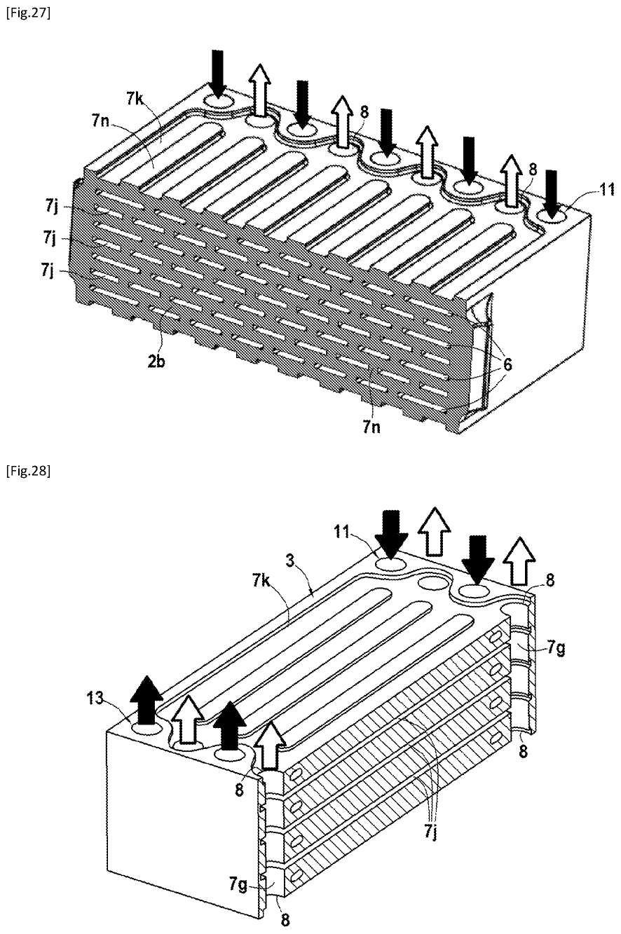

According to the example illustrated in FIGS. 1 and 2, the circulation ducts 6 are formed in the porous support 2 while not being parallel to each other. According to the embodiments illustrated in FIG. 3 and subsequent figures, the circulation ducts 6 are formed in the porous support 2 parallel to each other. It should be noted that in the examples illustrated in FIGS. 3 to 13 and 25 to 29, the circulation ducts 6 are delimited by two parallel planar faces which are parallel to the two outer planar surfaces 3, 4 of the porous support 2 whereas in the examples of FIGS. 14 to 24, the two parallel planar faces of the circulation ducts 6 are perpendicular to the two outer planar surfaces 3, 4 of the porous support 2.

It should be noted that according to an exemplary embodiment not illustrated, the porous support 2 may include at least one circulation duct 6 with a flexible volume while following the main direction of circulation of the fluid to be treated; a flexuous volume being defined by the displacement around a reference axis along a curvilinear trajectory, of a planar generating section, this reference axis not passing through said generating section and being contained in the volume of the porous support. At least one circulation duct has a periodic flexuous shape.

FIGS. 3 to 5 illustrate an exemplary embodiment of a separating element 1 made in the form of a flattened block of generally rectangular shape provided with nozzles 15 intended to be connected to an external circulation circuit for the liquid medium. This separating element 1 includes a porous support 2 including a first outer planar surface 3 and a second outer planar surface 4 parallel to each other located facing each other and interconnected by a connecting surface 5 arranged to form two connecting faces parallel to each other and two nozzles 15 at each of the two opposite ends of the porous support 2. The nozzles 15 extend in a direction whose angle relative to the main direction of flow of the fluid to be treated is equal to 0°. Of course, the nozzles 15 can extend in different directions, such as in directions whose angles relative to the main direction of circulation of the liquid medium are comprised between 0° and 90°.

Two circulation ducts 6 are formed in the porous support 2 parallel to each other and opposite each other and each have a rectangular cross section with a width at least four times less than the length. These two circulation ducts 10 are parallel to the outer planar surfaces 3, 4. These circulation ducts 6 are connected on one side with the internal connection system for the distribution 10 arranged in the porous support 2 and on the other side, with internal connection system for the collection 12 arranged in the porous support 2. The internal connection system for the distribution 10 opens onto the outside of the porous support 2 via a nozzle 15 in which the inlet 11 is formed, while the internal connection system for the collection 12 opens onto the outside of the porous support 2 through the other nozzle 15 in which the outlet 13 is formed. According to this example, the collection system 7 for the permeate P is not arranged in the porous support 2 so that the permeate is collected at the outer planar surfaces 3, 4 and at the connecting surface 5. Also, the collection system 7 which is located outside the porous support 2, is made by any appropriate systems to recover the permeate leaving the outer surface of the porous support 2, as a receptacle.

FIGS. 6 to 10 illustrate another exemplary embodiment of a separating element 1 made in the form of a flattened block of generally rectangular shape provided with nozzles 15 intended to be connected to an external circulation circuit for the liquid medium and nozzles 9 intended to be connected to an external permeate collection circuit, the collection system for the permeate 7 arranged in the porous support 2. This separating element 1 includes a porous support 2 including a first outer planar surface 3 and a second outer planar surface 4 parallel to each other and opposite each other by being interconnected by a connecting surface 5 arranged to form two connecting faces 51 parallel to each other. These two connecting faces 51 are interconnected at each of their ends, by the connecting surface 5 arranged to form, at one end, a nozzle 15 delimiting the inlet 11 for the liquid medium and a permeate collection nozzle 9 and at the other end, a nozzle 15 for the outlet 13 of the retentate R and another permeate collection nozzle 9. As shown in the drawings, the two nozzles 15 for the fluid medium and the retentate are aligned along the longitudinal axis of the separating element 1 while the permeate collection nozzles 9 are arranged symmetrically on either side of the nozzles 15 for the fluid medium and the retentate. Moreover, the nozzles 9, 15 extend in a direction whose angle relative to the main direction of circulation of the fluid to be treated is equal to 0° but it is clear that the nozzles 9, 15 can extend along different directions such as in directions whose angles relative to the main direction of circulation of the liquid medium are comprised between 0° and 90°.

Two circulation ducts 6 are formed in the porous support 2 parallel to each other and each have a rectangular cross section with a width substantially thirty times less than the length. These two circulation ducts 6 are parallel to the outer planar surfaces 3, 4. These circulation ducts 6 are connected on one side with the internal connection system for the distribution 10 and on the other side, with the internal connection system for the collection 12.

The internal connection system for the distribution 10 includes a common inlet segment 10e formed by a tubular conduit arranged in the nozzle 15 and opening onto the outside of the porous support 2 at the end of the nozzle 15, via the inlet 11 (FIG. 10). The common inlet segment 10e communicates opposite the inlet 11 via a bifurcation 10b formed in the porous support, with the two circulation ducts 6. Similarly, the internal connection system for the collection 12 includes a common outlet segment 12s formed by a tubular conduit arranged in the nozzle 15 and opening onto the outside of the porous support 2, at the end of the nozzle, via the outlet 13. The common outlet segment 12s communicates opposite the outlet 13, via a branch 12e arranged in the porous support 2, with the two circulation ducts 6.

According to this exemplary embodiment, the internal connection system for the distribution 10 and the internal connection system for the collection 12 are arranged symmetrically on either side of the circulation ducts 6, so that the nozzles 15 are centered on the longitudinal axis passing through the middle of the porous support 2. Of course, as indicated above, the internal faces of the internal connection system for the distribution 10, the internal faces of the circulation ducts 6 and the internal faces of the internal connection system for the collection 12 are provided with at least one separating layer.

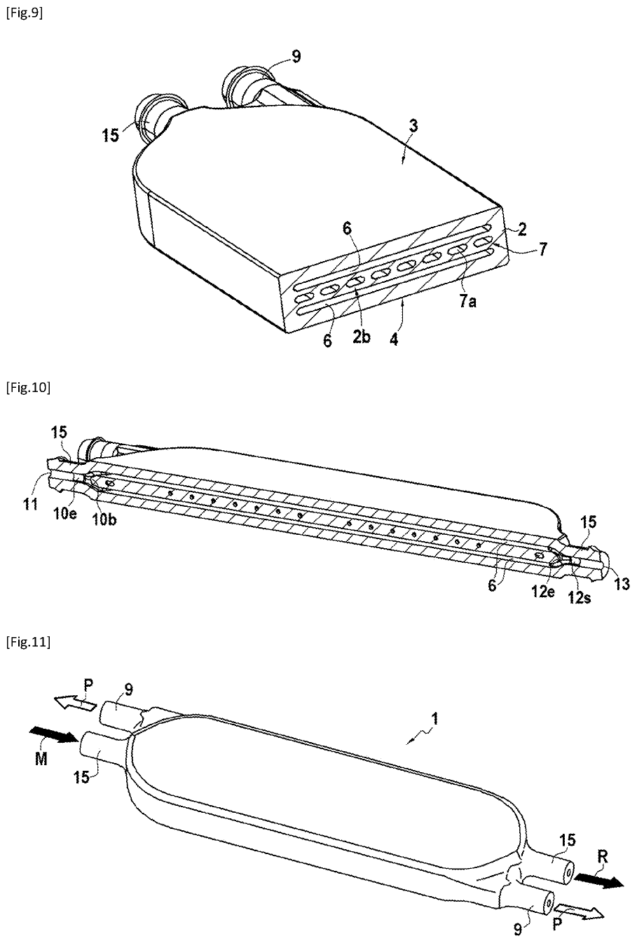

According to this exemplary embodiment, the collection system 7 for the permeate P is arranged in the porous support 2 so that the outer planar surfaces 3, 4 and the connecting surface 5 are sealed. Of course, the nozzles 15 delimiting the inlet 11 and the outlet 13 and the two permeate collection nozzles 9 which are formed by the connecting surface 5, are also sealed externally. As shown more precisely in FIGS. 8 and 9, the collection system 7 includes an array of eight channels 7a arranged in the support 2 parallel to each other according to the same plane and between the two circulation ducts 6 to recover the permeate P that has passed through the separating layer or layers and the support 2. The channels 7a are separated from each other by longitudinal partitions 2a and are separated from the circulation ducts 6 by partition walls 2b. These channels 7a communicate with each other at each end, by a collecting channel 7c extending by a conduit 7d arranged in a nozzle 9 to open onto the outside of the porous support 2, at the end of the nozzle 9. As is apparent from the drawings, a first outlet nozzle 9 for the permeate P is arranged parallel to the nozzle 15 defining the inlet 11 for the liquid medium, while a second outlet nozzle 9 for the permeate P is arranged parallel to the nozzle 15 defining the outlet 13 for the liquid medium.

According to this example of FIGS. 6 to 10, the nozzles 9, 15 for connection respectively to an external permeate recovery circuit and to the liquid medium supply and retentate outlet circuits are of the fluted tubular type. Of course, the connection nozzles 9, 15 can be arranged to have a connection system of a different type. FIG. 11 illustrates an exemplary embodiment of a separating element 1 identical to the example illustrated in FIGS. 6 to 10 with the difference that the nozzles 9, 15 are smooth. According to another embodiment not shown, the nozzles 9, 15 can be threaded.

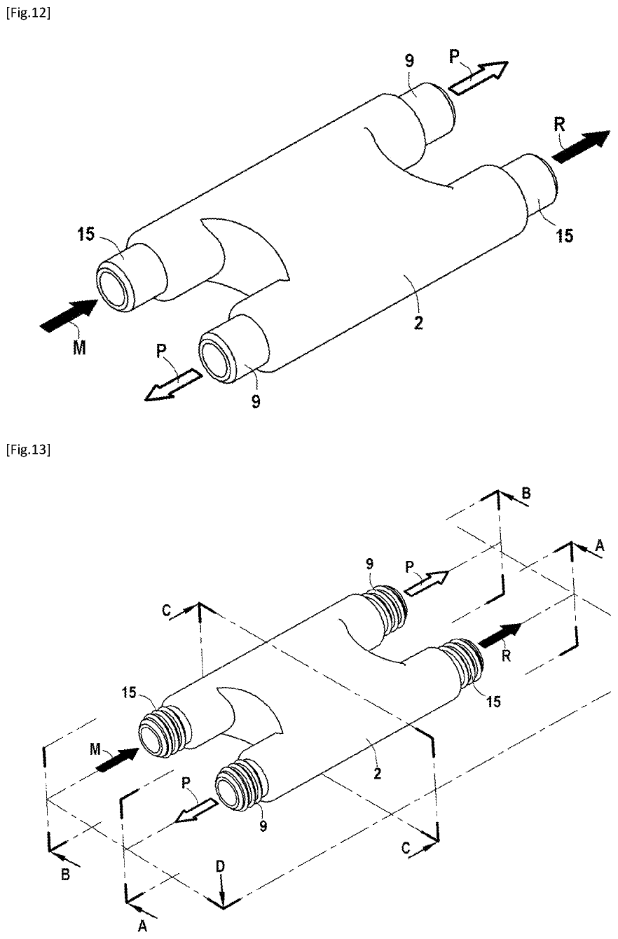

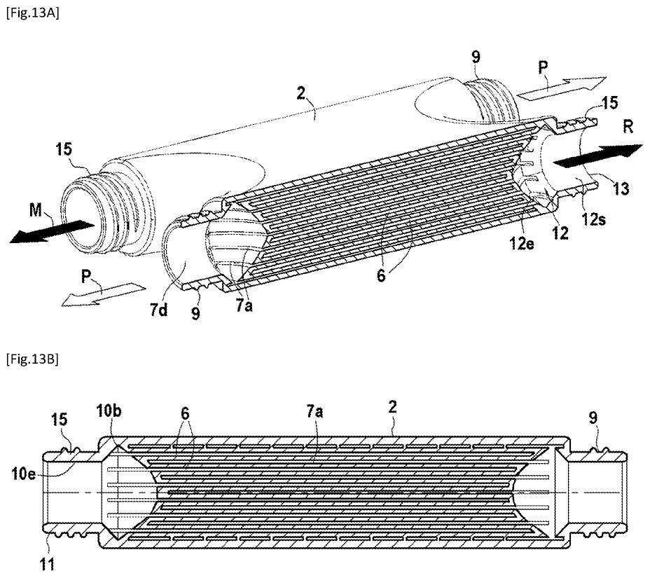

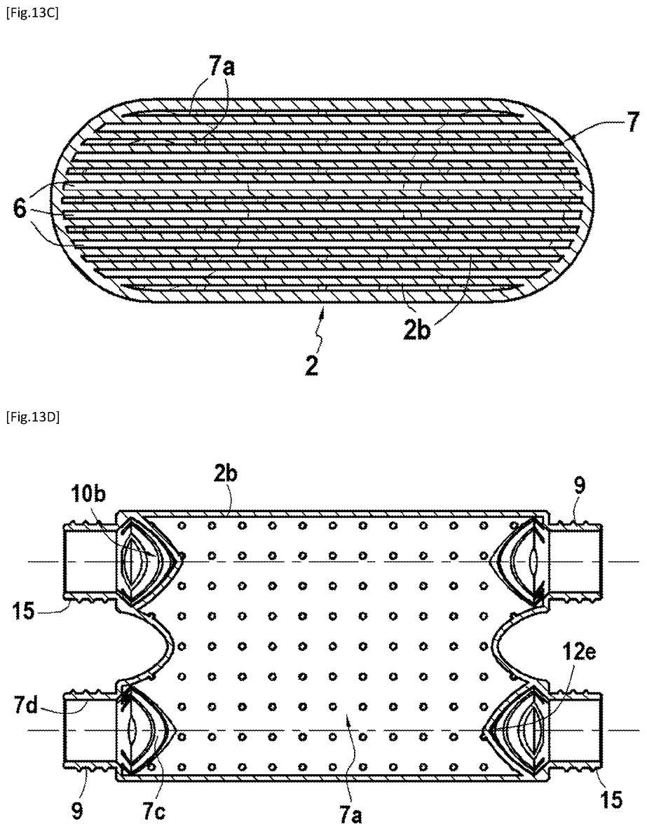

FIGS. 12 and 13, 13A-13D illustrate another exemplary embodiment of a separating element 1 having a design identical to the example illustrated in FIGS. 6 to 10, with the difference that the internal connection system 10 for the distribution of the liquid medium to be treated and the internal connection system 12 for the collection of the treated liquid medium are arranged asymmetrically on either side of the circulation ducts 6. Thus, the common elements between the separating element 1 described in FIGS. 6 to 10 and this other exemplary embodiment will not be repeated. The nozzle 15 defining the inlet 11 for the liquid medium is offset on one side with respect to the longitudinal axis passing through the middle of the porous support 2 while the nozzle 15 defining the outlet 13 for the permeate P is offset on the other side relative to the longitudinal axis passing through the middle of the porous support 2. Thus, the separating element 1 includes at each of its ends, an outlet nozzle 9 for the permeate P extending symmetrically with respect to the longitudinal axis passing through the middle of the porous support 2A, with a nozzle 15 defining the inlet 11 or the outlet 13.

As shown in the figures, this separating element 1 of generally flattened rectangular shape thus includes, at a first end, a nozzle 15 defining the inlet 11 and aligned with an outlet nozzle 9 for the permeate located at the second end, while this second end is provided with a nozzle 15 defining the outlet 13 and aligned with an outlet nozzle 9 for the permeate.

Six circulation ducts 6 are formed in the porous support 2 parallel to each other and each have a rectangular cross section with a width of the short sides substantially 50 times less than the length of the long sides. These six circulation ducts 6 are parallel to the outer planar surfaces 3, 4. These circulation ducts 6 are connected on one side with the internal connection system for the distribution 10 and on the other side, with the internal connection system for the collection 12.

The internal connection system for the distribution 10 includes a common inlet segment 10e formed by a tubular conduit arranged in the nozzle 15 and opening onto the outside of the porous support 2 at the end of the nozzle 15, via the inlet 11 (FIG. 13B). The common inlet segment 10e communicates opposite the inlet 11 via a bifurcation 10b formed in the porous support 2, with the six circulation ducts 6. Similarly, the internal connection system for the collection 12 includes a common outlet segment 12s formed by a tubular conduit arranged in the nozzle 15 and opening onto the outside of the porous support 2, at the end of the nozzle, via the outlet 13 (FIG. 13A). The common outlet segment 12s communicates opposite the outlet 13, via a branch 12e arranged in the porous support 2, with the six circulation ducts 6.

According to this exemplary embodiment, the internal connection system for the distribution 10 and the internal connection system for the collection 12 are arranged asymmetrically on either side of the circulation ducts 6. Of course, as indicated above, the internal faces of the internal connection system for the distribution 10, the internal faces of the circulation ducts 6 and the internal faces of the internal connection system for the collection 12 are provided with at least one separating layer.

According to this exemplary embodiment, the collection system 7 for the permeate P is arranged in the porous support 2 so that the outer planar surfaces 3, 4 and the connecting surface 5 are sealed. Of course, the nozzles 15 delimiting the inlet 11 and the outlet 13 and the two permeate collection nozzles 9 which are formed by the connecting surface 5, are also sealed externally. As shown more precisely in FIGS. 13C and 13D, the collection system 7 includes an array of seven channels 7a arranged parallel to each other and to the outer planar surfaces 3, 4, each in the form of a sheet. The channels 7a are inserted between the circulation ducts 6 and the outer planar surfaces 3, 4, being separated from the circulation ducts 6 by partitions 2b so as to recover the permeate P that has passed through the separating layer or layers and the partitions 2b of the support 2. These channels 7a communicate with each other via a collection chamber 7c extending by a conduit 7d arranged in each nozzle 9 to open onto the outside of the porous support 2, at the end of the nozzle 9, as illustrated in FIG. 13D for example. It should be noted that FIG. 13D shows the shape of the partitions 2b arranged in the porous support 2 to delimit the channels 7a but also the bifurcation 10b and the branch 12e.

It should be noted that FIG. 12 illustrates an exemplary embodiment of a separating element 1 for which the nozzles 9, 15 are smooth whereas in the exemplary embodiment illustrated in FIG. 13, the nozzles 9, 15 are threaded.

FIGS. 14 to 18 illustrate another exemplary embodiment of a separating element 1 belonging to the mode with connection orifices and produced in the shape of a rectangular parallelepiped block intended to be mounted in an apparatus 20 illustrated in FIGS. 30 and 31 and provided with connections to ensure on the one hand the entry of the liquid medium to be treated and the exit of the retentate as well as on the other hand the collection of the permeate. This separating element 1 includes a porous support 2 including a first outer planar surface 3 and a second outer planar surface 4 parallel to each other and opposite to each other, being interconnected by a connecting surface 5 arranged to form two large connecting faces 5g parallel to each other and interconnected at their ends by two small connecting faces 5p parallel to each other.

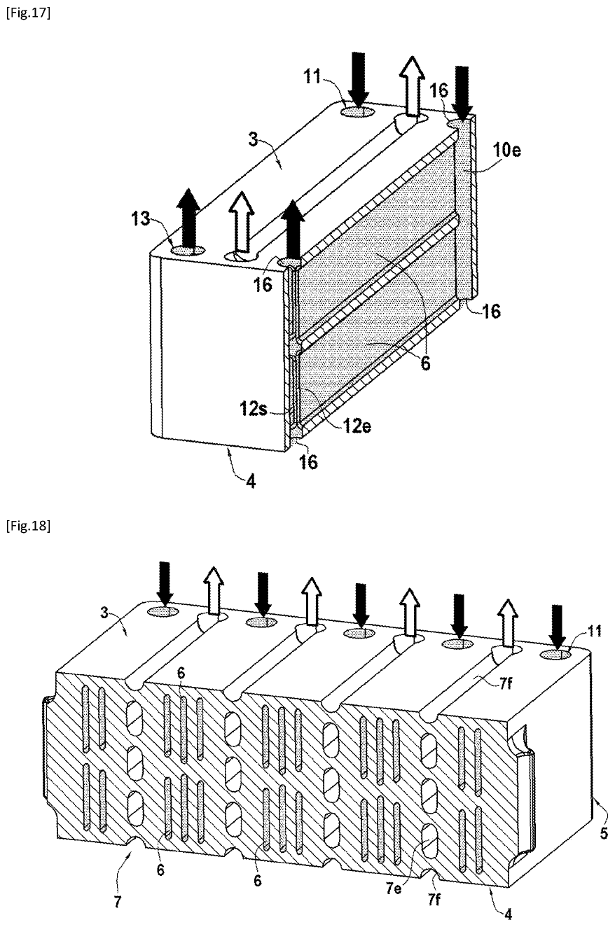

In the example illustrated, the separating element 1 includes five inlets 11 for the liquid medium M and five outlets 13 for the retentate R opening onto the outside of the porous support 10 through orifices 16 formed at the outer planar surface 3, or even also as illustrated in FIG. 17, at the second outer surface 4 to allow superimposed mounting of the separating elements 1 and communication for the fluid medium between the separating elements. The separating element 1 also includes two superimposed rows of five series of circulation ducts 6, each of which communicates with an inlet 11 via the internal connection system for the distribution 10 and an outlet 13 via the internal connection system for the collection 12.

In each superimposed row, three series have three circulation ducts 6 while two series include two circulation ducts 6. These circulation ducts 6 are formed in the porous support 2 parallel to each other, being separated by partition walls 2b. These circulation ducts 6 each have a rectangular cross section with a width substantially ten times less than the length. These circulation ducts 6 are perpendicular to the outer planar surfaces 3, 4. These circulation ducts 6 are connected on one side with the internal connection system for the distribution 10 including for each series of circulation ducts, a common inlet segment 10e formed by a tubular conduit communicating via a bifurcation 10b formed in the porous support 2, with all the ducts of a series and opening onto at least one, and in the example illustrated, onto the two outer planar surfaces 3, 4 through the orifices 16. These circulation ducts 6 are connected on the other side, with the internal connection system for the collection 12 including for each series of circulation ducts, a common outlet segment 12s formed by a tubular conduit communicating via a branch 12e arranged in the porous support 2, with all the ducts of a series and opening onto at least one, and in the example illustrated, onto the two outer planar surfaces 3, 4, through the orifices 16.

For the circulation ducts 6 of each series, the internal connection system for the distribution 10 and the internal connection system for the collection 12 are arranged in the porous support 2 symmetrically on either side of the circulation ducts 6, with the orifices 16 arranged along two lines symmetrical with respect to the longitudinal axis parallel to the large connecting faces 5g and passing through the middle of the porous support 2. The common inlet segments 10e and the common outlet segments 12s extend parallel to a direction which is perpendicular to the outer planar surfaces 3, 4 but also perpendicular to the main direction of circulation of the liquid medium. The common inlet segments 10e are arranged parallel to each other and close to a large connecting face 5g while the common outlet segments 12s are arranged parallel to each other and close to the other large connecting face 5g.

Of course, the number of circulation ducts 6 per series, the number of series of circulation ducts 6 and the number of rows of circulation ducts 6 are given only by way of illustration. Similarly, as indicated above, the internal faces of the internal connection system for the distribution 10, the internal faces of the circulation ducts 6 and the internal faces of the internal connection system for the collection 12 are provided with at least one separating layer.

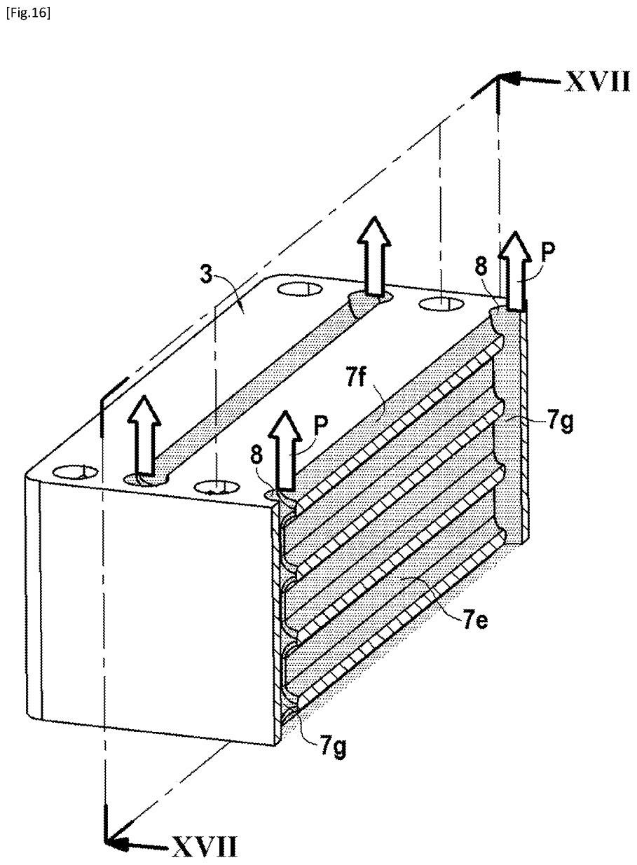

According to this example, the collection system 7 for the permeate P is arranged in the porous support 2 but also recessed in at least one, and in the example illustrated, the two outer planar surfaces 3, 4 of the porous support 2 to collect the permeate that has passed through the separating layer or layers. The collection system 7 thus includes, as illustrated in FIGS. 16 and 18, on the one hand, four series of three superposed channels 7e arranged in the porous support 2 between the two outer planar surfaces 3, 4 and between two adjacent series of circulation ducts 6 and on the other hand, a gutter 7f arranged in each outer planar surface 3, 4, in alignment with each series of channels. The three channels 7e and the two gutters 7f of each of these series communicate at each end with tubular cavities 7g opening out through orifices 8 formed on at least one, and in the example illustrated, on the two outer planar surfaces 3, 4. The tubular cavities 7g are arranged parallel to each other but also parallel to the common inlet segments 10e and to the common outlet segments 12s. Advantageously, part of the tubular cavities 7g and the common inlet segments 10e are arranged in the same plane while another part of the tubular cavities 7g and the common outlet segments 12s are arranged in the same plane.

It should be noted that the rest of the outer planar surfaces 3, 4 not arranged in recesses or in gutters 7f is sealed. In other words, all the outer planar surfaces 3, 4 are sealed with the exception of the gutters 7f. Similarly, the connecting surface 5 is sealed. The connection of the orifices 8, 16 respectively to an external permeate recovery circuit and to a circulation circuit for the liquid medium will be described in more detail in the following description in relation to FIGS. 30 and 31.

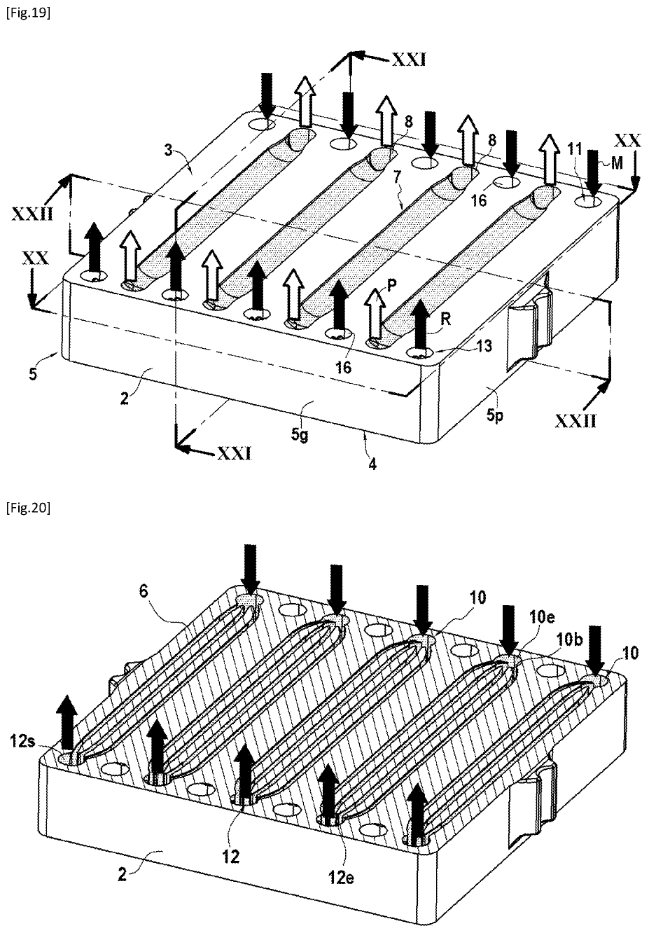

FIGS. 19 to 24 illustrate another exemplary embodiment of a separating element 1 relating to the mode with connection orifices and produced in the form of a rectangular parallelepiped. This exemplary embodiment is identical in design to the example illustrated in FIGS. 14 to 18, with the difference that the permeate recovery system 7 is produced only on the surface of the porous support 2. This separating element 1 includes a porous support 2 including a first outer planar surface 3 and a second outer planar surface 4 parallel to each other and opposite to each other while being interconnected by a connecting surface 5 arranged to form two large connecting faces 5g parallel to each other and interconnected at their ends by two small connecting faces 5p parallel to each other.

The separating element 1 includes five inlets 11 for the liquid medium M and five outlets 13 for the retentate R opening out onto the outside of the porous support 10 through orifices 16 formed at the outer planar surface 3, or also as illustrated in FIG. 21, at the second outer surface 4 to allow superimposed mounting of the separating elements 1. In the example illustrated in FIGS. 19 to 22, the separating element 1 includes a row of five series of circulation ducts 6, each of which communicates with an inlet 11 via the internal connection system for the distribution 10 and an outlet 13 via the internal connection system for the collection 12. Of course, the number of circulation ducts 6 per series, the number of series of circulation ducts 6 and the number of rows of circulation ducts 6 are given only by way of illustration. By way of example, FIGS. 23 and 24 illustrate a variant embodiment identical to the variant embodiment illustrated in FIGS. 19 to 22 with the difference that the circulation ducts 6 are distributed in two superimposed rows.

Each row includes five series of circulation ducts 6 of which the three central series each include six circulation ducts 6 while the two end series located close to the small connecting faces 5p each include four circulation ducts 6. These circulation ducts 6 are formed in the porous support 2 parallel to each other and each have a rectangular cross section with a width substantially ten times less than the length. These circulation ducts 6 are perpendicular to the outer planar surfaces 3, 4. These circulation ducts 6 are connected on one side with the internal connection system for the distribution 10 arranged in the porous support 2 and including for each series of circulation ducts, a common inlet segment 10e formed by a tubular conduit communicating, via a bifurcation 10b formed in the porous support 2, with all the ducts of a series and opening onto at least one, and in the example illustrated, onto the two outer planar surfaces 3, 4 through the orifices 16. These circulation ducts 6 are connected on the other side, with the internal connection system for the collection 12 arranged in the porous support 2 and also including for each series of circulation ducts, a common outlet segment 12s formed by a tubular conduit communicating via a branch 12e arranged in the porous support, with all the ducts of a series and opening onto at least one, and in the example illustrated, onto the two outer planar surfaces 3, 4 through the orifices 16. For the circulation ducts 6 of each series, the internal connection system for the distribution 10 and the internal connection system for the collection 12 are arranged symmetrically on either side of the circulation ducts 6, with the orifices 16 arranged along two lines symmetrical with respect to the longitudinal axis parallel to the large connecting faces 5g and passing through the middle of the porous support 2. As indicated above, the internal faces of the internal connection system for the distribution 10, the internal faces of the circulation ducts 6 and the internal faces of the internal connection system for the collection 12 are provided with at least one separating layer.

According to the exemplary embodiments illustrated in FIGS. 19 to 24, the collection system 7 for the permeate P is not arranged inside the porous support 2 but only recessed in at least one and, in the example illustrated, the two outer planar surfaces 3, 4 of the porous support 2 to collect the permeate that has passed through the separating layer or layers. The collection system 7 thus includes, as illustrated in FIGS. 19 to 24, four series of two superimposed gutters 7f arranged in the outer planar surfaces 3, 4, as already described in the example illustrated in FIGS. 14 to 18. The two gutters 7f of each of these series communicate at each end with tubular cavities 7g formed in the porous support, opening out through orifices 8 formed on at least one and, in the example illustrated, on both outer planar surfaces 3, 4. It should be noted that the rest of the outer planar surfaces 3, 4 not arranged in recesses or gutters 7f is sealed. Similarly, the connecting surface 5 is sealed. The connection of the orifices 8, 16 respectively to an external permeate recovery circuit and to a circulation circuit for the liquid medium will be described in more detail in the following description in relation to FIGS. 30 and 31.

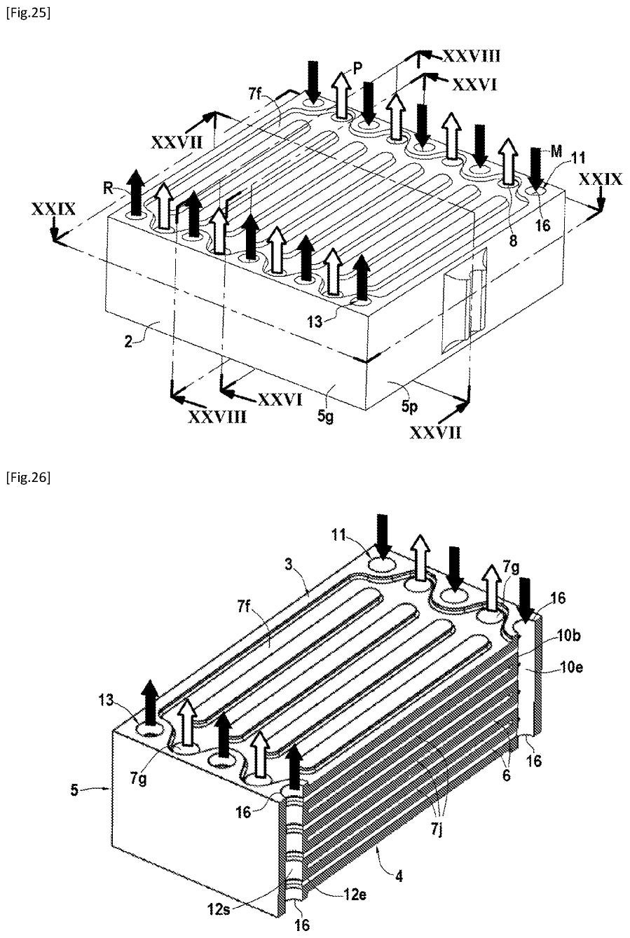

FIGS. 25 to 29 illustrate another exemplary embodiment of a separating element 1 relating to the mode with connection orifices and produced in the shape of a rectangular parallelepiped block intended to be mounted in an apparatus 20 illustrated in FIGS. 30 and 31 and provided with connections to ensure on the one hand the entry of the liquid medium to be treated and the exit of the retentate as well as on the other hand the collection of the permeate. This exemplary embodiment differs from the exemplary embodiment illustrated in FIGS. 14 to 18 insofar as the circulation ducts 6 are arranged parallel to the outer planar surfaces 3, 4 unlike the example of FIGS. 14 to 18 for which the circulation ducts 6 are arranged perpendicular to the outer planar surfaces 3, 4.

This separating element 1 includes a porous support 2 including a first outer planar surface 3 and a second outer planar surface 4 parallel to each other and opposite to each other, being interconnected by a connecting surface 5 arranged to form two large connecting faces 5g parallel to each other and interconnected at their ends by two small connecting faces 5p parallel to each other.

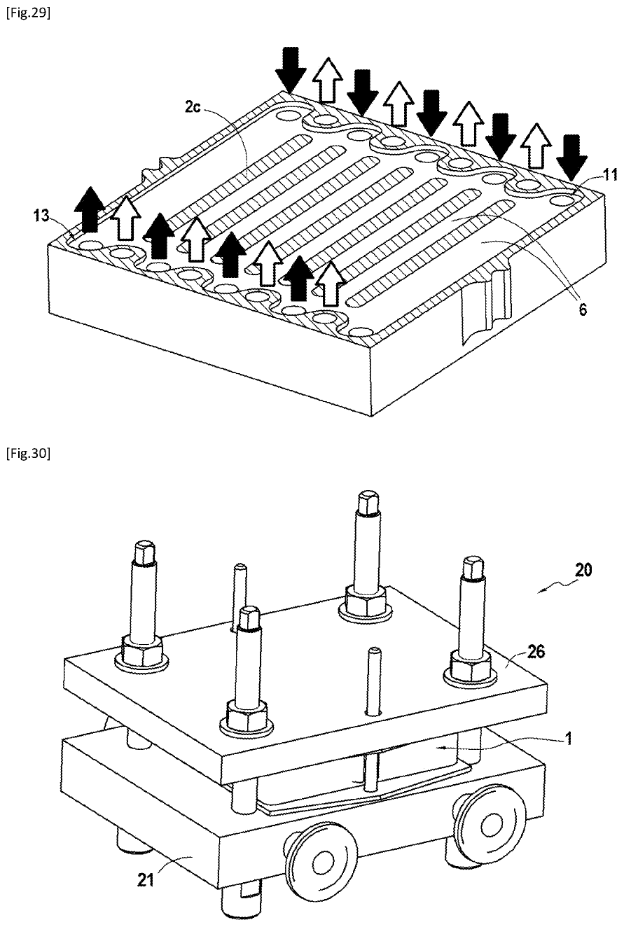

The separating element 1 includes five inlets 11 for the liquid medium M and five outlets 13 for the retentate R opening out onto the outside of the porous support 10 through orifices 16 formed at the outer planar surface 3, or also as illustrated in FIG. 26, at the second outer surface 4 to allow a superposed assembly of the separating elements 1. The separating element 1 also includes circulation ducts 6 arranged in the porous support to communicate with the inlets 11 via the internal connection system for the distribution 10 and the outlets 13 via the internal connection system for the collection 12. The circulation ducts 6 are arranged on four superimposed stages by forming two series of four superimposed circulation ducts and three series of four pairs of superimposed circulation ducts. As shown more specifically in FIG. 29, in each stage, the circulation ducts 6 are separated by partition walls 2c made by the porous support 2 extending parallel to each other and to the main direction of circulation of the liquid medium between the inlets 11 and the outlets 13 of the liquid medium. Note that these partition walls 2c are not continuous from one end to the other of the porous support, thus allowing communication between the circulation ducts 6 of each stage, at the inlets 11 and the outlets 13 of the liquid medium.

These circulation ducts 6 are formed in the porous support 2 parallel to each other and parallel to the outer planar surfaces 3, 4. These circulation ducts 6 each have a rectangular cross section with a width at least four times less than the length. These circulation ducts 6 are connected on one side with the internal connection system for the distribution 10 including, for each series of circulation ducts, a common inlet segment 10e formed by a tubular conduit communicating via a bifurcation 10b, with all the ducts of a series and opening onto at least one, and in the example illustrated, onto the two outer planar surfaces 3, 4 through the orifices 16 and on the other side, with the internal connection system for the collection 12 including for each series of circulation ducts, a common outlet segment 12s formed by a tubular conduit communicating via a branch 12e with all the ducts of a series and opening onto at least one, and in the example illustrated, onto the two outer planar surfaces 3, 4 through the orifices 16.

For the circulation ducts 6 of each series, the internal connection system for the distribution 10 and the internal connection system for the collection 12 are arranged in the porous support 2 symmetrically on either side of the circulation ducts 6, with the orifices 16 arranged along two lines symmetrical with respect to the longitudinal axis parallel to the large connecting faces 5g and passing through the middle of the porous support 2. The common inlet segments 10e and the common outlet segments 12s extend parallel to a direction which is perpendicular to the outer planar surfaces 3, 4 but also perpendicular to the main direction of circulation of the liquid medium. The common inlet segments 10e are arranged parallel to each other and close to a large connecting face 5g while the common outlet segments 12s are arranged parallel to each other and close to the other large connecting face 5g.

Of course, the number of circulation ducts 6 per series, the number of series of circulation ducts 6 and the number of rows of circulation ducts 6 are given only by way of illustration. Similarly, as indicated above, the internal faces of the internal connection system for the distribution 10, the internal faces of the circulation ducts 6 and the internal faces of the internal connection system for the collection 12 are provided with at least one separating layer.

According to this example, the collection system 7 for the permeate P is arranged in the porous support 2 but also recessed in at least one, and in the example illustrated, the two outer planar surfaces 3, 4 of the porous support 2 to collect the permeate that has passed through the separating layer or layers. The collection system 7 thus includes, as illustrated in FIGS. 25, 27 and 28, three superimposed collection layers 7j arranged in the porous support 2 between the two outer planar surfaces 3, 4 and between two neighboring stages of circulation ducts 6 as well as a recessed area 7k formed in each outer planar surface 3, 4. The collection sheets 7j are interposed between two adjacent circulation ducts 6, being separated from the circulation ducts 6 by partition walls 2b.

In the example illustrated, it should be noted that in each collection layer 7j, stiffening ribs 7n are arranged in the porous support parallel to each other to delimit parallel channels joining at each of their ends to lead on each side, to a series of four tubular cavities 7g opening out via orifices 8 formed on at least one, and in the example illustrated, on the two outer planar surfaces 3, 4. The tubular cavities 7g are arranged parallel to each other but also parallel to the common inlet segments 10e and to the common outlet segments 12s. Advantageously, a first series of tubular cavities 7g and the common inlet segments 10e are arranged in the same plane while a second series of the tubular cavities 7g and the common outlet segments 12s are arranged in the same plane.

Similarly, stiffening ribs 7n produced by the porous support are arranged projecting in the outer planar surfaces 3, 4 parallel to each other so that each recessed area 7k has parallel channels joining at each of their ends to lead on each side, to a series of four tubular cavities 7g. The three layers of channels 7j and the two recessed areas 7k of each of these series communicate at each end with tubular cavities 7g opening out through orifices 8 formed on at least one, and in the example illustrated, on both outer planar surfaces 3, 4.

It should be noted that the rest of the outer planar surfaces 3, 4 which are not recessed are sealed. Thus, the stiffening ribs 7n made by the porous support projecting into the outer planar surfaces 3, 4 are sealed. Similarly, the connecting surface 5 is sealed. The connection of the orifices 8, 16 respectively to an external permeate recovery circuit and to a circulation circuit for the liquid medium will be described in more detail in the following description in relation to FIGS. 30 and 31.

FIGS. 30 and 31 illustrate an exemplary embodiment of a commercial apparatus 20 provided with connections for the connection of at least one separating element 1 relating to the mode with connection orifices 8, 16 and in accordance with one of the variants illustrated in FIGS. 14 to 29. This apparatus provided with one or more separating elements 1 thus form a separation unit for a fluid medium of all types. According to this example, the apparatus 20 includes a connection plate 21 on which at least one separating element 1, mounted in a sealed manner by seals 24, is intended to be fixed by threaded rods 22 and nuts 23 between this connection plate 21 and a tie plate 26. The connection plate 21 includes orifices 21M positioned to communicate on the one hand with the orifices 16 of the inlets 11 of the separating element 1 and on the other hand, with a circuit for supplying the liquid medium 27 of which only part is shown in the drawings. The connection plate 21 also includes orifices 21R positioned to communicate on the one hand with the orifices 16 of the outlets 13 of the separating element 1 and on the other hand, with a retentate recovery circuit 28 only a part of which is shown in the drawings. The connection plate 21 also includes orifices 21P positioned to communicate on the one hand with the orifices 8 of the collection system for the permeate and on the other hand, with an external permeate recovery circuit 29.

In the context of the invention, the manufacture of the porous support 2, or even of the separating element as a whole, can be carried out using an additive technique, the method consisting in obtaining one-piece parts by adding or agglomeration of material, the subject taking shape as successive layers are stacked. Of course, this additive method is configured or adapted so that the porosity of the porous material of the porous support ensures the routing of the permeate that has passed through the separating layer or layers. The method has the advantage, compared to other techniques such as the assembly by gluing of different parts manufactured separately, of producing the support in a single production step and of allowing access to a wide range of shapes and sizes and of forming the circulation ducts for the liquid medium to be treated and for the collection of the permeate. Among the additive techniques, SLS (Selective Laser Sintering), FDM (Fused Deposition Modeling) from a filament or granules, PEM (Paste Extrusion Modeling) and BJ (Binder Jetting) are particularly well adapted.

In the case of the use of a solid material such as a powder, the thickness of the powder bed and therefore of each successively consolidated stratum is relatively low to allow its connection to the lower stratum, by application of a contribution of energy (SLS) or the projection of a binder liquid (BJ). In particular, a thickness of 20 μm to 200 μm of powder will be deposited, this thickness depending on the additive technique selected. It is the repetition of the binary sequence depositing a bed of powder followed by consolidation which allows, stratum after stratum, to build the desired three-dimensional shape. The consolidation pattern may vary from one stratum to another. The growth of the desired three-dimensional shape is carried out according to a chosen direction of growth. In the case of the use of a ceramic composition in the form of a ceramic paste (PEM) or a filament or hot-melt granules (FDM), the thickness of a stratum is defined by a set of cords, whether continuous or discontinuous, juxtaposed or not juxtaposed, which are extruded at the same altitude taken along the chosen direction of growth.

According to an advantageous embodiment characteristic, the material constituting the porous support has a maximum admissible bending stress of at least 10 MPa, this characteristic resulting from the three-dimensional continuity and the three-dimensional homogeneity that allow additive techniques on the one hand and necessary post sintering heat treatment on the other hand.

This maximum bending characteristic associated with the geometry of the porous support (dimensioning, thickness of the external or internal walls, . . . ) as well as the continuity of the material and the porous texture allow to define a porous support capable of offering sufficient mechanical strength to prevent this porous support 2 from breaking under the effect of a stress generated by the pressure difference of the liquid medium between the separating layer and the permeate outlet surface, said permeate outlet surface corresponding either to the inner surface delimiting the collection system for the permeate 7 when the latter is arranged in the porous support 2, or to the outer surface of the separating element 1 when the collection system 7 is not arranged in the porous support 2.

The difference in pressure of the liquid medium between the separating layer and the outlet surface of the permeate commonly corresponds to what the person skilled in the art calls the transmembrane pressure (TMP). This pressure difference is defined in the context of the invention by the average of the supply PA (this is the absolute pressure measured at the inlet of the liquid medium to be treated) and retentate PR pressures (this is the absolute pressure measured at the outlet of the treated liquid medium) from which one subtracts either the absolute pressure Pp measured in the collection system for the permeate 7 when the latter is arranged in the porous support 2, or the atmospheric pressure Pa when the collection system 7 is arranged outside the porous support 2. The transmembrane pressure (TMP) is such that:

$$PTM = \frac{{P}_{A} + {P}_{R}}{2} - {P}_{p}$$

On the basis of this definition, the characteristics of the material and the dimensioning of the porous support, these last two points being developed above, the porous support 2 is defined so that no degradation by breaking the porous material appears for a pressure difference of the liquid medium greater than or equal to 1 bar.

There is breakage as soon as the inorganic one-piece rigid porous support 2 has at least one crack or a fracture with or without localized displacement of the porous material at the location of said crack(s) or fracture(s) and when said breakage, interrupting the porous continuity, opens a direct passage for the liquid between, on the one hand, the assembly formed by the internal connection system 10 for the distribution of the liquid medium to be treated, by the circulation ducts 6 and by the internal connection system 12 for the collection of the retentate and on the other hand the collection system 7 for the permeate without said liquid having to pass through the filtration layer.

Such a breakage is immediately observable by a drop in the transmembrane pressure defined as the pressure difference of the liquid medium between the separating layer and the outlet surface of the permeate on the one hand as well as by an increase in the flow present in the collection system for the permeate on the other hand. The flow rate of treated liquid being abnormally increased by that of the untreated liquid, this mixture of permeate and retentate causes the breakage to make the use of the separating element unsuitable. The latter is then considered destroyed and must be replaced.

1. An element for separating a liquid medium into a permeate and a retentate, comprising:
an inorganic one-piece rigid porous support (2) having, on one side, a first outer planar surface (3) and, on an opposite side, a second outer planar surface (4) connected to the first outer planar surface by at least one outer connecting surface (5);
at least one series of at least two circulation ducts (6) for the liquid medium that are formed in the porous support so as to each have a rectangular cross section defined by two long sides parallel to each other and two short sides parallel to each other;
at least one internal connection system for the distribution (10) of the liquid medium, arranged in the porous support to distribute from an inlet (11) formed in the porous support, the liquid medium, in a series of at least two circulation ducts, and at least one internal connection system for the collection (12) of the retentate, arranged in the porous support to collect up to an outlet (13) formed in the porous support, the retentate coming from the series of at least two circulation ducts, the internal connection system for the distribution (10), the circulation ducts (6) and the internal connection system for the collection (12) being provided with at least one separating layer continuously deposited between the inlet (11) and the outlet (13) of the porous support so that the liquid medium circulating in the porous support between the inlet and the outlet is only in contact with said separating layer, the porous support (2) having a continuity of material and of porous texture and a mechanical strength allowing to prevent the breaking of the porous support for a pressure difference of the liquid medium of at least one bar between the separating layer and the outlet surface of the permeate; and
a collection system (7) for the permeate that has passed through the separating layer or layers.

2. The separating element according to claim 1, wherein the porous support (2) is obtained by the implementation of an additive method configured so that the porosity of the porous material ensures the routing of the permeate that has passed through the separating layer or layers.

3. The element according to claim 1, wherein the material constituting the porous support (2) has a maximum admissible bending stress of at least 10 MPa.

4. The element according to claim 1, wherein the rectangular cross section of the circulation ducts (6) has two dimensions, one of the dimensions of which is at least four times smaller than the other dimension.

5. The separating element according to claim 1, wherein several circulation ducts (6) are formed in the porous support (2) parallel to each other.

6. The separating element according to claim 1, wherein at least one circulation duct (6) has a flexible shape while following the main direction of circulation of the fluid to be treated.

7. The separating element according to claim 1, wherein at least one circulation duct (6) has a periodic flexible shape.

8. The separating element according to claim 1, wherein each circulation duct (6) has a constant cross section over its entire extent between the internal connection system for the distribution (10) and the internal connection system for the collection (12).

9. The separating element according to claim 1, wherein the circulation ducts (6) are delimited by two parallel faces which are perpendicular or parallel to at least two outer planar surfaces (3, 4) of the porous support.

10. The separating element according to claim 1, wherein the internal connection system for the distribution (10) and the internal connection system for the collection (12) open onto the outside of the porous support (2) via one or more orifices (16) or nozzles (15) arranged at an outer planar surface (3, 4) or at an outer connecting surface (5).

11. The separating element according to claim 1, wherein the internal connection system for the distribution (10) and the internal connection system for the collection (12) are arranged asymmetrically on either side of the circulation ducts (6).

12. The separating element according to claim 1, wherein the internal connection system for the distribution (10) and the internal connection system for the collection (12) are arranged symmetrically on either side of the circulation ducts (6).

13. The element according to claim 1, wherein the collection system for the permeate (7) includes spaces arranged inside the porous support to collect the permeate that has passed through the separating layer or layers.

14. The separating element according to claim 13, wherein the collection system for the permeate (7) opens onto the outside of the porous support via one or more orifices (8) or nozzles (9) for collecting said permeate.

15. The separating element according to claim 1, wherein the first outer planar surface (3), the second outer planar surface (4) and the outer connecting surface (5) are sealed.

16. The element according to claim 1, wherein the collection system for the permeate (7) is recessed in at least one outer planar surface (3, 4) of the porous support to collect the permeate that has passed through the separating layer or layers, the rest of the outer planar surface not recessed being sealed.

17. The separating element according to claim 1, wherein the porous support (2) includes nozzles (15) sealed on the outside, delimiting the inlet (11) of the internal connection system for the distribution (10) and the outlet (13) of the internal connection system for the collection (12).

18. The separating element according to claim 17, wherein said nozzles (15) extend along directions whose angles relative to the main direction of circulation of the liquid medium are comprised between 0° and 90°.

19. A separation unit comprising the separating element (1) according to claim 1 mounted in an apparatus (20) provided with connections (21M, 21R, 21P) to ensure on the one hand the entry of the liquid medium to be treated and the exit of the retentate as well as on the other hand the collection of the permeate.

20. The separation unit according to claim 19, wherein the nozzles (15) of which delimit the inlet of the internal connection system for the distribution (10) of the liquid medium to be treated and the outlet of the internal connection system for the collection (12) of the retentate, as well as the nozzle or nozzles (9) for collecting the permeate are equipped with connections fixed in a sealed manner to said nozzles.
